(19) United States
(12) Patent Application Publication
(10) Pub. No.: US 2009/0228559 A1
(43) Pub. Date: Sep. 10, 2009

(54) RATING SYSTEM FOR INSTANT MESSAGING (IM)

(75) Inventors: STEVE R. CAMPBELL, LILLINGTON, NC (US); TODD E. KAPLINGER, RALEIGH, NC (US)

Correspondence Address: PATENTS ON DEMAND, P.A. IBM-RSW, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 12/043,418

(22) Filed: Mar. 6, 2008

(51) Int. Cl. G06F 15/16

(52) U.S. Cl. 709/206

(57) ABSTRACT

User ratings can be received from Instant Messaging (IM) users, such as ratings for other users established via an IM application interface. Each received user rating can represent a rating corresponding to an IM communicator. The received user ratings can be processed to establish a global rating for the IM communicator. The global rating can be conveyed to IM clients along with an identifier of the IM communicator. IM applications can present these global rating to IM users, who can also configure behavior of the IM applications based upon global IM ratings. In one embodiment, categories can be established, which results in category specific IM ratings, which can be used in a manner similar to the global IM ratings.

### BACKGROUND OF THE INVENTION

The present invention relates to the field of instant messaging (IM); and, more particularly, to a rating system for IM, where peers can rate other IM communicators and view ratings applied to IM communicators.

IM communications are real time communications between two or more parties, where text, media, data, and voice can be exchanged. For purposes of this description, IM is defined broadly to include chatting and text messaging based technologies.

Most IM systems employ the use of an online status, giving users the ability to set when they're available, busy, or away from the computer. Before another user can view your online status, most IM systems require that user to add you to a contact list or a “buddy list,” or list of possible communication partners. If someone is not on a contact list, they can often still initiate an IM communication, which must be “accepted” by a recipient. IM is such a convenient communication technique, that many IM communicators are beginning to become bombarded with solicitations via IM or become overloaded with a myriad of IM communication attempts from parties with whom they have little desire to communicate.

Some current IM systems have implemented a solution to protect their users' privacy and to minimize unwanted IM communication attempts. For example, AOL Instant Messenger (AIM) employs the use of both a blocking system and a “knock-knock” solution. Their blocking system allows users to specify lists of users that can or cannot contact you. The “knock-knock” solution can be configured to prompt a user whether or not to accept instant messages from a peer that you have not communicated with before. AIM also uses a warning function, which allows users to “warn” communication peers when they act inappropriately. As a peer gets warned, their current “warning level,” is increased. If a user's warning level gets too high, they can be forced to disconnect for a period of time. Thus, an IM communicator who is “pestering” others, as indicated by the multiple warnings sent to an IM server, is automatically suspended from the IM service.

Although these solutions add some functionality to helping users' manage the IM communicators that can contact them, they leave a lot to be desired. For example, using a list of users that can or cannot contact you can be tough to manage depending on the number of contacts that end up reaching the lists. Also, if a peer is trying to be malicious, they can create multiple accounts and contact a user again after they've been blocked as another username. Further, a malicious IM recipient can intentionally try to “suspend” another for malicious purposes under the knock-knock system. Additionally, a knock-knock system forces uniform action against IM users that apply to all IM users, even though some may have different communication desires from others. Since the knock-knock system is warning based, a minority of users aggressively using the knock-knock functions can also have a disproportionate effect, which may not even reflect desires of an “average” IM user. The “knock-knock” solution also doesn't display any information regarding the user besides their username. A user doesn't get an idea of the person trying to contact them when they're presented with an option to communicate.

### BRIEF SUMMARY OF THE INVENTION

One aspect of the present invention can include a method, computer program product, system, and apparatus for IM communications. In the aspect, user ratings can be received from IM users. Each received user rating can represents a rating corresponding to an IM communicator. The received user ratings can be processed to establish a global rating for the IM communicator. The global rating can be conveyed to IM clients along with an identifier of the IM communicator.

Another aspect of the present invention can include a system for IM communications that includes a rating acceptor, a rating processor, and a rating provider. The rating acceptor can accept user provided ratings corresponding to specific IM users. The rating processor can generate at least one global rating for the specific IM users based upon the user provided ratings accepted by the rating acceptor. The rating provider can convey global ratings determined by the rating processing to IM users.

Still another aspect of the present invention can include an IM user interface that includes a rating input control, a rating submission control, and a rating presentation control. The rating input control can accept input to be used for rating at least one external IM communicator. The rating submission control can be used to submit input entered into the rating input control to an IM server. The rating presentation control can be used to present a rating associated with at least one IM communicator, which is provided by the IM server based upon ratings values provided by a set of different IM users for the IM communicator.

### BRIEF DESCRIPTION OF THE SEVERAL VIEWS OF THE DRAWINGS

FIG. 1 is a schematic diagram of a system for using a rating system for instant messaging in accordance with an embodiment of the inventive arrangements disclosed herein.

FIG. 2 shows a user interface that includes an IM rating capability in accordance with an embodiment of the inventive arrangements disclosed herein.

FIG. 3 is a flow chart of a method for using a rating system for instant messaging in accordance with an embodiment of the inventive arrangements disclosed herein.

### DETAILED DESCRIPTION OF THE INVENTION

The present invention discloses a solution for using a rating system for instant messaging (IM) communications. The solution allows users to rate their communications with other IM users and can optionally permit an inclusion of comments. These ratings can be processed to create an overall rating for user, which other users can see. The optional comments can also be viewed. These ratings can be helpful for permitting other IM users to determine whether they wish to communicate with a rated user or not. For example, an IM user receiving an IM communication from another IM user with a low rating, may choose to ignore the IM communication. In one embodiment, IM users can configure settings, which take automated actions based in part upon IM ratings. For example, for all users not on a contract list that have IM ratings under a configurable threshold, incoming attempts can be automatically blocked or otherwise disfavored in accordance with user configured settings. The configurable settings and rules applied to IM communications based upon these settings can be of an arbitrary level of complexity, which can vary from implementation-to-implementation of the disclosed solution depending on implementation specific concerns.

The present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. Examples of a computer-readable medium include a semiconductor or solid state memory, magnetic tape, a removable computer diskette, a random access memory (RAM), a read-only memory (ROM), an erasable programmable read-only memory (EPROM or Flash memory, a rigid magnetic disk and an optical disk. Current examples of optical disks include compact disk - read only memory (CD-ROM), compact disk - read/write (CD-R/W) and DVD. Other computer-readable medium can include a transmission media, such as those supporting the Internet, an intranet, a personal area network (PAN), or a magnetic storage device. Transmission media can include an electrical connection having one or more wires, an optical fiber, an optical storage device, and a defined segment of the electromagnet spectrum through which digitally encoded content is wirelessly conveyed using a carrier wave.

Note that the computer-usable or computer-readable medium can even include paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

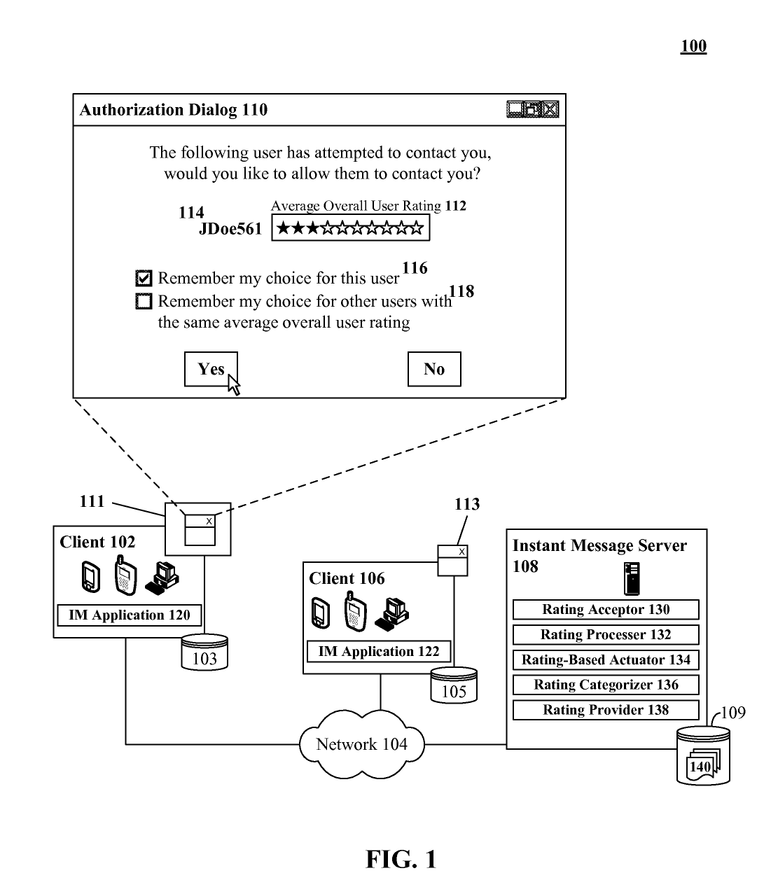

FIG. 1 is a schematic diagram of a system 100 for using a rating system for instant messaging in accordance with an embodiment of the inventive arrangements disclosed herein. In system 100, clients 102 and 106 can communicate with instant message server 108 via network 104 using IM application 120 and 122. The IM applications 120, 122 can have associated interfaces 111 and 113. At least one of the interfaces 111, 113 can include an interface option (e.g., dialog 110, for example) that presents an IM rating 112 for an associated IM user 114. Additional and related options for performing programmatic actions based upon the IM rating 112 can also appear within the dialog 1 10.

The user rating 112 for an IM user 114 can be based upon a set of ratings provided by different IM users. That is, the interfaces 111, 113 can permit users to establish ratings for other IM users, which are received by a rating acceptor 130. These ratings can be processed by a rating processor 132, which generates user rating 112 from discrete user provided rating values in accordance with a mathematical algorithm. In one embodiment, a rating-based actuator 134 can execute a set of ratings based actions for IM communications. In another embodiment, a rating categorizer 136 can generate different user ratings 112 based upon definable categories of feedback providers. A rating provider 138 can convey ratings to IM clients 102, 106 for use by the IM applications 120, 122.

In one embodiment, users of the IM applications 120, 122 can configure settings that adjust rating based behavior. The settings can, for example, be stored within user profiles 140 in data store 109. In another embodiment, IM rating configuration settings can be stored in client-side data stores 103 and/or 105. While in one embodiment, many of the rating-based components 130-138 are server side components, in a different implementation one or more of these components 130-138 (e.g., actuator 134) can be implemented as client-side components and/or as services performed by a network element of network 104.

As used herein, an IM is defined broadly to refer to any of a variety of real-time communication technologies that utilize packet-based communications, which include chat based communication technologies, text message based technologies, instant message based technologies, and the like. Further IM communications can include text exchanges, data exchanges, audio exchanges, video exchanges, and the like. IM communications can include exchanges between a human communicator and an automated software agent, between two human communicators, and/or between more than two communicators.

The IM applications 120, 122 can be dedicated communication applications or can be components of an application having IM communication capabilities (e.g., many multiplayer or online video games, for example, include IM communication capabilities). IM applications 120, 122 can also include stand-alone applications as well as served applications executing within a Web browser. It should be noted that during an IM communication involving two or more communicators using different IM applications 120, 122, one of the applications 120, 122 can include rating 112 enhancements, while another does not. That is, the user rating 112 capabilities can be an enhancement that still permits IM communications to occur with “standard” non-enhanced clients.

The clients 102, 106 can be any computing device capable of IM communications. For example, clients 102, 106 can include a personal computer, a notebook computer, a smart phone, a personal data assistant, a communication kiosk, a wearable computer, a consumer electronic device, and the like.

The IM server 108 can facilitate IM communications between clients 102, 106. The IM server 108 can optionally include a presence awareness component (not shown), such as one used to provide availability information presented in a contact list or “buddy list.” IM server 108 can include rating acceptor 130, rating processor 132, rating-based actuator 134, rating categorizer 136, rating provider 138, and/or other components. The components 130-138 can be implemented in software, firmware, and/or hardware. Although not shown, the server 108 can include all necessary components (e.g., memory, CPU, operating system, etc.) to execute programmatic instructions of the components 130-138.

The rating acceptor 130 accepts user provided ratings for other IM users. The rating provider 138 can provide user ratings to other IM users. Both the acceptor 130 and the provider 138 can be configured to function with IM applications 120, 122 and IM interfaces 111, 113, which have been enhanced to permit a use and/or establishment of IM ratings.

The rating-based actuator 134 is configured to change IM communication processing based upon IM ratings of communicators. For example, an IM user can establish a setting to hide their presence from other IM users, who have an associated user rating of less than a designated value. Additionally, the rating-based actuator 134 may automatically permit communications with IM users having a rating of over eighty percent positive based upon one hundred or more user provided ratings. Individual user settings can tailor a user's IM experience using the IM ratings. Similarly, different settings can be established to vary actuator 134 behaviors on an application 120, 122 specific basis.

The rating categorizer 136 can categorize feedback in accordance with any definable criteria. Different category specific IM ratings can be determined, presented, and/or used to control programmatic actions. For example, the categorizer 136 can establish a company specific rating for Company ABC based only upon feedback provided by users associated with Company ABC. In another example, 136, the IM server 108 can handle IM communications for a number of different social networking sites, and a social networking site specific IM rating can be handled by categorizer 136. Other categories can include, but are not limited, application specific categories (e.g., IM ratings associated with a particular video game having IM capabilities), role specific categories, topic basic categories, and the like.

The rating processor 132 can generate IM ratings, global and category specific, based upon user provided feedback. Any mathematical algorithm can be used to calculate these ratings. For example, an IM rating can be based upon an average rating, a mean rating, a medium rating, and the like. In another example, weighs can be selectively applied to feedback of “trusted” users. For example, a feedback weight can be based in part upon an IM rating of a user providing the feedback. Additionally, in one embodiment, different levels of confidence in a rating can be calculated and presented to IM users. For example, a confidence rating can be based in part upon a quantity of feedback provided by divergent sources.

Data stores 103, 105, and 109 can be physically implemented within any type of hardware including, but not limited to, a magnetic disk, an optical disk, a semiconductor memory, a digitally encoded plastic memory, or any other recording medium. Data stores 103, 105, and 109 can be stand-alone storage units as well as a storage unit formed from a plurality of physical devices, which may be remotely located from one another. Additionally, information can be stored within the data stores 103, 105, and 109 in a variety of manners. For example, information can be stored within a database structure or can be stored within one or more files of a file storage system, where each file may or may not be indexed for information searching purposes.

The network 104 can include any hardware/software/and firmware necessary to convey digital content encoded within carrier waves. Content can be contained within analog or digital signals and conveyed through data or voice channels and can be conveyed over a personal area network (PAN) or a wide area network (WAN). The network 104 can include local components and data pathways necessary for communications to be exchanged among computing device components and between integrated device components and peripheral devices. The network 104 can also include network equipment, such as routers, data lines, hubs, and intermediary servers which together form a packet-based network, such as the Internet or an intranet. The network 104 can further include circuit-based communication components and mobile communication components, such as telephony switches, modems, cellular communication towers, and the like. The network 104 can include line based and/or wireless communication pathways.

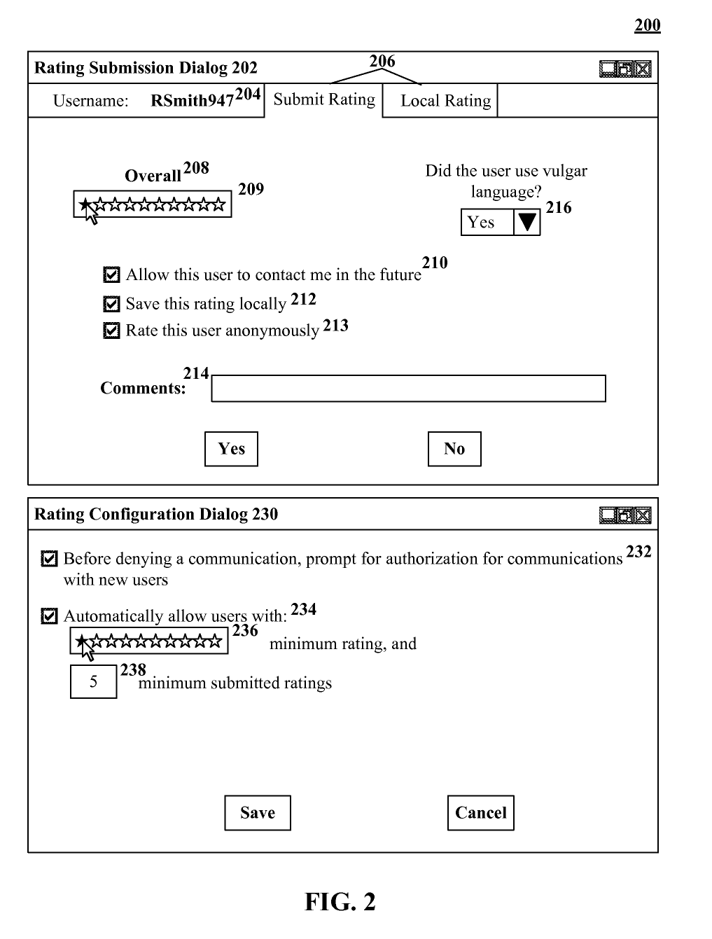

FIG. 2 shows a user interface that includes an IM rating capability in accordance with an embodiment of the inventive arrangements disclosed herein. In one embodiment, the interface of FIG. 2 can represent an interface 110 and/or an interface 113 implemented in context of system 100. The interface can include dialog 202 and dialog 230. Although shown as a graphical user interface, other types of interfaces (such as voice user interfaces and multimodal interfaces) are also contemplated. Further, specifics shown in dialog 202 and 230 are for illustrative purposes only and are not to be construed as invention constraints.

Dialog 202 is a rating submission dialog 202. Rating submission dialog 202 can be used to submit local ratings 206, remote ratings 206, or both. A local rating 206 being a specific category of IM rating for an intranet. In implementations including a categorizer, other rating specific tabs 206 relating to different categories can be included in dialog 202.

Dialog 202 can contain a variety of options, such as an overall rating 208-209, vulgar language option 216, express permission option 210, local save option 212, anonymous option 213, tabs 206, and comments 214.

Overall rating 208, 209 can be an interface control configured to allow a user to specify a rating for username 204, which is an IM user other than the one utilizing dialog 202. In this example, a set of stars is shown to allow a user to click the star in which to rate the user. In embodiments, the rating can be designated and displayed in any way. For example, the rating 208, 209 could be displayed as a number and the rating can be designated by selecting the number from a slider, or typing it into a text edit control. It is also contemplated that in other embodiments, more options can be present to allow the designation of ratings for other things pertaining to username 204.

Vulgar language option 216 can be an option present to denote that the user uses vulgar language. Vulgar option 216 can be used to alert other users that a certain user uses a lot of profanity. In some embodiments, vulgar option 216 can also be used for parental controls (not shown).

Express permission option 210 can be an option (shown as a checkbox) to grant the user express permission to be able to contact the user. Express permission option 210 can essentially put username 204 on a list of “trusted” users.

Local save option 212 can be an option (shown as a checkbox) to save the same rating for username 204 locally. This can allow the user to keep the same rating for their own records, or uncheck this to rate the user differently.

Anonymous option 213 can be an option (shown as a checkbox) to allow the rating submission to be anonymous. Anonymous option 213 can enable or disable the inclusion of the username of the person submitting the rating. These options appear as a checkbox but can be implemented as any GUI control. It is also contemplated that some of these options can be omitted depending on the implemented system.

Comments 214 can be a field to allow a user to submit a textual rating for username 204. Comments 214 can be used for specific complaints about a user. For example, someone can comment that a user asked for their credit card information, attempted to spread a virus, or the like.

Rating configuration dialog 230 can include such options as prompt 232 and required rating settings 234-238.

Prompt option 232 is an option that can be configured for security settings based on rating. If enabled, prompt option 232 can prompt the user for permission before denying a peer. This can allow the user to have the option to deny a user, rather than automatically denying them. It is contemplated that in many embodiments, option 232 or options 234-238 can be implemented, rather than both.

Required rating options 234-238 can allow a user to specify minimum rating requirements for a peer to contact them. Option 236 allows a user to select a minimum star rating. Option 238 allows a user to specify a minimum number of submitted ratings. With these options set as shown (a minimum 1 star rating and 5 minimum submitted ratings), if a peer attempted to contact the user who hadn't received any ratings, they could be automatically denied permission. It is also contemplated that if used in conjunction with option 232, rather than automatically denying permission, the user can be prompted to give permission to the peer.

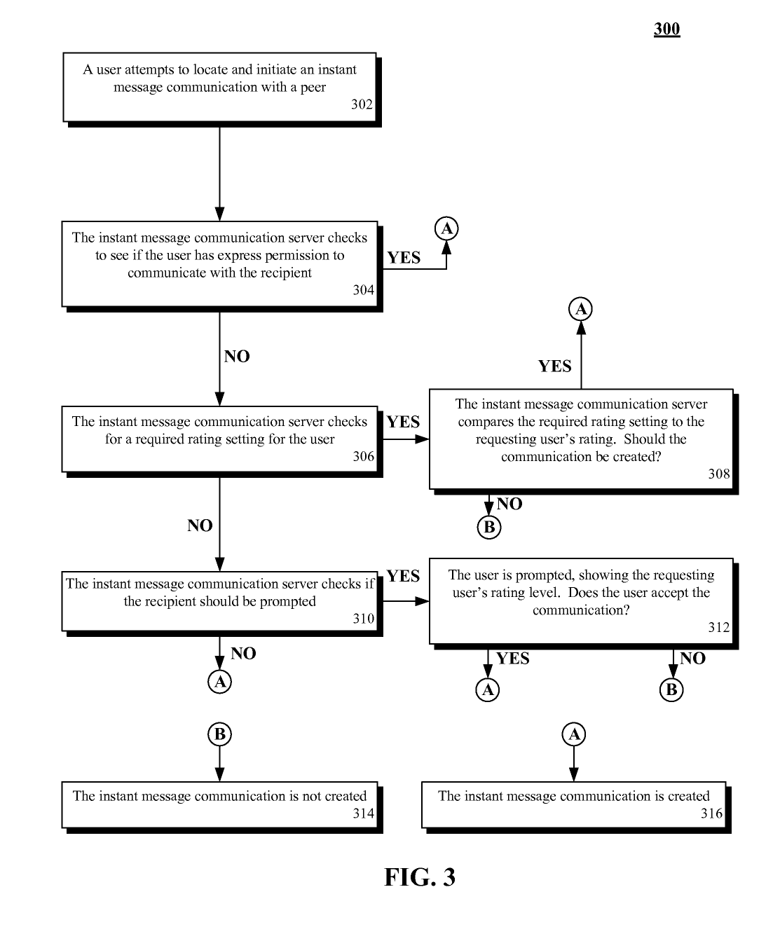

FIG. 3 is a flow chart of a method 300 for using a rating system for instant messaging in accordance with an embodiment of the inventive arrangements disclosed herein. Method 300 can be performed in the context of a system 100 or other IM system enhanced for IM ratings.

Method 300 can begin in step 302, where a user can attempt to locate and initiate an instant message communication with a peer. In step 304, the instant message communication server can check to see if the user has express permission to communicate with the recipient. In this step, the server can check for a previously set explicit permission for the peer. For example, the recipient might know that this user was going to contact them, and can have added them to a list of users exempt from security limitations. If in step 304, the user does have express permission to communicate with the recipient, method 300 can continue to step 316, where the instant message communication can be created.

If in step 304, the user does not have express permission to communicate with the recipient, method 300 can continue to step 306, where the instant message communication server can check for a required rating setting for the user. If in step 306, the user does have a required rating setting, method 300 can continue to step 308, where the instant message communication server can compare the required rating setting to the requesting user's rating. In this step, it can be determined if the user has set a minimum required submitted ratings and what the minimum required rating is. In step 308, if the requesting user's rating meets the required rating, or fits in the rating threshold, method 300 can continue to step 316, where the instant message communication can be established. If in step 308, the requesting user's rating does not meet the requirements, method 300 can continue to step 314 where the instant message communication cannot be denied.

In step 306, if a required rating setting hasn't been set for the user, method 300 can continue to step 310, where the instant message communication server can check if the recipient should be prompted to grant permission to the requesting user. If in step 310, it is determined that the user should be prompted, method 300 can continue to step 312, where the user can be prompted, showing the requesting user's rating level. In this step, if the user accepts the communication, method 300 can continue to step 316, where the instant message communication can be established. If in step 312, the user does not accept the communication, method 300 can continue to step 314, where the instant message communication cannot be created and permission can be refused. In step 310, if the user should not be prompted for permission, method 300 can continue to step 316, where the instant message communication can be created.

The diagrams in FIGS. 1-3 illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for IM communications comprising:
receiving user ratings from IM users, where each received user rating represents a rating corresponding to an IM communicator;
processing the received user ratings, to establish a global rating for the IM communicator; and
conveying the global rating to IM clients along with an identifier of the IM communicator.

2. The method of claim 1, wherein at least one of the IM clients is configured to present the global rating for IM communication attempts involving the IM communicator.

3. The method of claim 1, further comprising:
at least a portion of the IM users, establishing user configured IM communication settings, which cause different processing actions to be performed based upon values of global ratings, wherein said IM users comprise a first IM user having an associated first set of IM communication settings that define a first set of processing actions, and a second IM user having an associated second set of IM communication settings that define a second set of processing actions, wherein the first set of IM communication settings are different from the second set of IM communication settings, wherein the first set of processing actions are different from the second set of processing actions;
the IM communicator attempting to initialize a first IM communication with the first IM user;
processing the first IM communication using the first set of IM communication settings and performing the first set of processing actions; and
the IM communicator attempting to initialize a second IM communication with the second IM user; and
processing the second IM communication using the second set of IM communication settings and performing the second set of processing actions.

4. The method of claim 3, wherein at least a portion of the different processing actions, where the portion of the different processing actions comprise the first set of processing actions and a second set of processing actions are server-side actions executed by an IM server.

5. The method of claim 3, wherein at least a portion of the different processing actions, where the portion of the different processing actions comprise the first set of processing actions and a second set of processing actions are client-side actions executed by client-side IM applications, one of the client-side IM applications being an IM application used by the first IM user and another of the client-side IM applications being an IM application used by the second IM user.

6. The method of claim 1, further comprising:
receiving user comments from the IM users that correspond to the IM communicator;
storing the received user comments in a data store accessible by an IM server; and
selectively conveying the received user comments to the IM users.

7. The method of claim 1, wherein the receiving of user ratings occurs from IM clients associated with the IM users to an IM server, wherein the processing of received ratings is performed by the IM server, which stores the global rating for the IM communicator in a data store accessible by the IM server, and wherein the global ratings are conveyed from the IM server to IM clients along with an identifier of the IM communicators.

8. A computer program product for IM communications, the computer program product comprising:
a computer usable medium having computer usable program code embodied therewith, the computer usable program code comprising:
computer usable program code configured to receive user ratings from IM users, where each received user rating represents a rating corresponding to an IM communicator;
computer usable program code configured to process the received user ratings, to establish a global rating for the IM communicator; and
computer usable program code configured to convey the global rating to IM clients along with an identifier of the IM communicator.

9. The computer program product of claim 8, further comprising:
computer usable program code configured to receive user comments from the IM users that correspond to the IM communicator;
computer usable program code configured to store the received user comments in a data store accessible by an IM server; and
computer usable program code configured to selectively convey the received user comments to the IM users.

10. A system for Instant Messaging (IM) communications comprising:
a rating acceptor configured to accept user provided ratings corresponding to specific IM users;
a rating processor configured to generate at least one global rating for the specific IM users based upon the user provided ratings accepted by the rating acceptor; and
a rating provider configured to convey global ratings determined by the rating processing to IM users.

11. The system of claim 10, wherein the rating acceptor is further configured to accept user provided comments corresponding to the specific IM users, and wherein the rating provider is further configured to provide the user provided comments to IM users.

12. The system of claim 10, further comprising:
a rating based actuator configured to perform different programmatic actions related to IM communications based upon global ratings associated with IM users involved in the IM communications.

13. The system of claim 12, further comprising:
a data store configured to store a plurality of user profiles, wherein said user profiles include user configured settings, which define the different programmatic actions that are to be performed for IM communications involving an IM user associated with the user profile.

14. The system of claim 10, further comprising:
a rating categorizer configured to segment different user provided ratings into different categories, wherein the rating processor is configured to generate category ratings based upon the different categories, and wherein the rating provider is further configured to convey the category ratings determined by the rating processor to IM users.

15. The system of claim 10, wherein the rating acceptor, the rating processor, and the rating provider are software implemented components comprising a plurality of programmatic instructions configured to be executed by an IM server, wherein the software implemented components are stored in a machine usable medium.

16. An Instant Messaging (IM) user interface comprising:
a rating input control configured to accept input to be used for rating at least one external IM communicator;
a rating submission control configured to submit input entered into the rating input control to an IM server; and
a rating presentation control configured to present a rating associated with at least one IM communicator, which is provided by the IM server based upon ratings values provided by a plurality of different IM users for the IM communicator.

17. The IM user interface of claim 16, wherein the rating input control, the rating submission control, and the rating presentation controls are controls of a graphical user interface, wherein said graphical user interface further comprises:
IM communication controls configured to facilitate IM communications.

18. The IM user interface of claim 16, wherein the rating input control, the rating submission control, and the rating presentation controls are speech-enabled controls of at least one of a Voice User interface and a multimodal interface.

19. The IM user interface of claim 16, further comprising:
a comment input control configured to accept input for commenting about the at least one external IM communicator;
a comment submission control configured to submit input entered into the comment input control to the IM server; and
a comment presentation control configured to present a set of comments associated with at least one IM communicator, which is provided by the IM sever based upon comments provided by a plurality of different IM users for the IM communicator.

20. The IM user interface of claim 16, further comprising:
a configuration control configured to permit a user to define a unique set of programmatic actions that are to be applied to IM communications based at least in part upon ratings associated with IM communicators involved in the IM communications.
